(19) United States
(12) Patent Application Publication
(10) Pub. No.: US 2024/0389674 A1
(43) Pub. Date: Nov. 28, 2024

(54) INDUCTION HEATING SYSTEM, CONTROL METHOD, AND NON-TRANSITORY COMPUTER READABLE MEDIUM

(71) Applicant: Japan Tobacco Inc., Tokyo (JP)

(72) Inventors: Nobuhiro TATSUTA, Tokyo (JP); Yuichi KAMO, Tokyo (JP); Ryota SHIMASAKI, Tokyo (JP)

(73) Assignee: Japan Tobacco Inc., Tokyo (JP)

(21) Appl. No.: 18/795,234

(22) Filed: Aug. 6, 2024

Related U.S. Application Data
(63) Continuation of application No. PCT/JP2022/006856, filed on Feb. 21, 2022.

(51) Int. Cl. A24F 40/57; A24F 40/20; A24F 40/465; A24F 40/51; H05B 6/06; H05B 6/10

(52) U.S. Cl. CPC A24F 40/57; A24F 40/20; A24F 40/465; A24F 40/51; H05B 6/06; H05B 6/105

(57) ABSTRACT

An induction heating system including: an LC circuit that includes an electromagnetic induction source generating a variable magnetic field; a temperature sensor that detects temperature; and a control unit that, after starting application of an alternating current to the LC circuit, controls frequency of the alternating current applied to the LC circuit on the basis of the temperature detected by the temperature sensor.

### CROSS-REFERENCE TO RELATED APPLICATION

This application is a Continuation of PCT International Application No. PCT/JP2022/006856, filed on Feb. 21, 2022, which is hereby expressly incorporated by reference into the present application.

### TECHNICAL FIELD

The present invention relates to an induction heating system, a control method, and a non-transitory computer readable medium.

### BACKGROUND ART

Inhaler devices that generate a substance to be inhaled by users, such as electronic cigarettes and nebulizers, are widely used. An inhaler device generates an aerosol with a flavor component, for example, using a substrate including an aerosol source for generating an aerosol and a flavor source for imparting a flavor component to the generated aerosol. A user can taste a flavor by inhaling the aerosol with the flavor component generated by the inhaler device. Inhalation, by the user, of an aerosol will be referred to as a “puff” or a “puff action” hereinafter.

In recent years, induction heating inhaler devices that generate an aerosol by heating, through induction heating, a susceptor and heating an aerosol source through the susceptor have been developed. In the following Patent Literature 1, for example, a technique for estimating temperature of a susceptor on the basis of a frequency characteristic during induction heating is disclosed.

### CITATION LIST

### Patent Literature

Patent Literature 1: JP 2020-516014 A

### SUMMARY OF INVENTION

### Technical Problem

Induction heating inhaler devices are known to be capable of efficiently heating an aerosol source. There is, however, room for improvement in heating efficiency.

The present invention, therefore, has been conceived in view of the above problem and aims to provide a mechanism capable of further improving the heating efficiency.

### Solution to Problem

In order to solve the above problem, an aspect of the present invention provides an induction heating system including an LC circuit including an electromagnetic induction source that generates a varying magnetic field, a temperature sensor that detects a temperature, and a controller that controls frequency of an alternating current applied to the LC circuit on a basis of the temperature detected by the temperature sensor after a start of the application of the alternating current to the LC circuit.

The induction heating system may further include a memory storing correspondence between a temperature and the frequency of the alternating current applied to the LC circuit when the temperature sensor detects the temperature. The controller may control the frequency of the alternating current applied to the LC circuit on a basis of the correspondence stored in the memory.

The temperature sensor may detect a temperature of the electromagnetic induction source.

The frequency of the alternating current applied to the LC circuit may correspond to a resonant frequency of the LC circuit.

The LC circuit may be an LC series circuit.

The induction heating system may further include a container that accommodates a substrate including an aerosol source. The electromagnetic induction source may heat, through induction heating, a susceptor disposed in thermal proximity to the aerosol source.

The substrate may include the susceptor.

The induction heating system may further include the susceptor.

The induction heating system may further include the substrate.

The controller and the memory may be a single control device.

In addition, in order to solve the above problem, another aspect of the present invention provides a control method for controlling an induction heating system including an LC circuit that includes an electromagnetic induction source which generates a varying magnetic field and a temperature sensor that detects a temperature includes controlling frequency of an alternating current applied to the LC circuit on a basis of the temperature detected by the temperature sensor after a start of the application of the alternating current to the LC circuit.

In addition, in order to solve the above problem, another aspect of the present invention provides a program executed by a computer that controls an induction heating system including an LC circuit that includes an electromagnetic induction source which generates a varying magnetic field and a temperature sensor that detects a temperature causing the computer to function as a controller that controls frequency of an alternating current applied to the LC circuit on a basis of the temperature detected by the temperature sensor after a start of the application of the alternating current to the LC circuit.

### Advantageous Effects of Invention

As described above, according to the present invention, a mechanism capable of further improving the heating efficiency is provided.

### BRIEF DESCRIPTION OF DRAWINGS

FIG. 1 is a schematic diagram schematically illustrating a configuration example of an inhaler device according to an embodiment.

FIG. 2 is a block diagram illustrating structural elements related to induction heating performed by the inhaler device according to the present embodiment.

FIG. 3 is a diagram illustrating an example of configuration of a driving circuit according to the present embodiment.

FIG. 4 is a diagram illustrating another example of the configuration of the driving circuit according to the present embodiment.

FIG. 5 is a flowchart illustrating an example of a procedure of a heating process performed by the inhaler device according to the present embodiment.

FIG. 6 is a graph illustrating a result of an experiment for checking effects produced by the present embodiment.

### DESCRIPTION OF EMBODIMENTS

A preferred embodiment of the present invention will be described in detail hereinafter with reference to the accompanying drawings. Structural elements having substantially the same functional configuration will be given the same reference numerals herein and in the drawings, and redundant description thereof is omitted.

### 1. Configuration Example

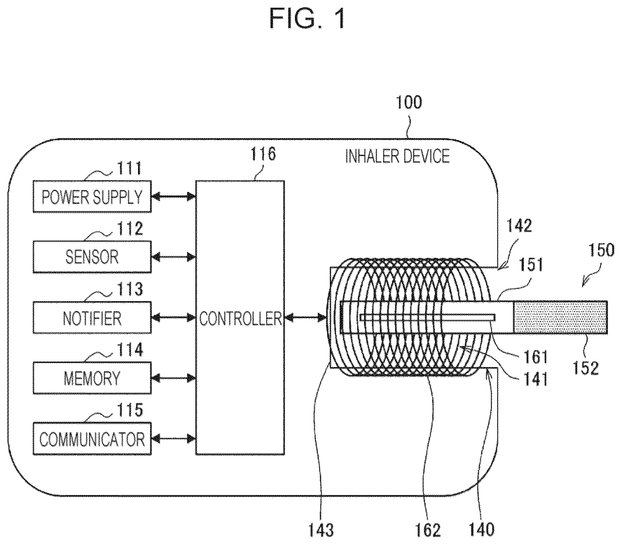

FIG. 1 is a schematic diagram schematically illustrating a configuration example of an inhaler device 100 according to the embodiment. As illustrated in FIG. 1, the inhaler device 100 according to the present configuration example includes a power supply 111, a sensor 112, a notifier 113, a memory 114, a communicator 115, a controller 116, an electromagnetic induction source 162, and a container 140. A user inhales with a stick substrate 150 accommodated in the container 140. The structural elements will be described hereinafter one by one.

The power supply 111 stores electric power. The power supply 111 supplies electric power to the structural elements of the inhaler device 100. The power supply 111 may be a rechargeable battery such as a lithium ion secondary battery. The power supply 111 may be charged after being connected to an external power supply through USB (universal serial bus) cable or the like. The power supply 111 may be charged using a wireless power transmission technique without being connected to a power transmission device, instead. Alternatively, only the power supply 111 may be removed from the inhaler device 100 and replaced by a new power supply 111.

The sensor 112 detects various items of information regarding the inhaler device 100. The sensor 112 then outputs the detected information to the controller 116. In an example, the sensor 112 may be a pressure sensor such as a condenser microphone, a flow sensor, or a temperature sensor. When the sensor 112 detects a value generated in accordance with the user's inhalation, the sensor 112 outputs information indicating the user's inhalation to the controller 116. In another example, the sensor 112 may be an input device that receives information input by the user, such as a button or a switch. In particular, the sensor 112 can include a button for requesting a start and a stop of generation of the aerosol. The sensor 112 then outputs the information input by the user to the controller 116. In another example, the sensor 112 may be a temperature sensor that detects a temperature of a susceptor 161. The temperature sensor detects the temperature of the susceptor 161 on the basis of, for example, an electrical resistance of the electromagnetic induction source 162.

The notifier 113 notifies the user of information. In an example, the notifier 113 may be a light-emitting device such as an LED (light-emitting diode). In this case, the notifier 113 emits light in different light emission patterns depending on, for example, whether the power supply 111 needs to be charged, the power supply 111 is being charged, or an abnormality has occurred in the inhaler device 100. The light emission patterns are a concept including color, on/off timing, and the like. The notifier 113 may be a display device that displays an image, a sound output device that outputs sound, a vibration device that vibrates, or the like in addition to, or instead of, the light-emitting device. The notifier 113 may also provide information indicating that a state where the user can inhale has been established. The information indicating that the state where the user can inhale has been established can be provided when temperature of the stick substrate 150 heated through electromagnetic induction reaches a certain temperature.

The memory 114 stores various items of information for operation of the inhaler device 100. The memory 114 may be, for example, anon-volatile storage medium such as flash memory. An example of the information stored in the memory 114 is information regarding an OS (operating system) of the inhaler device 100, such as how the controller 116 controls the various structural elements. Another example of the information stored in the memory 114 is information regarding the user's inhalation, such as the number of times of inhalation, inhalation times, and total inhalation time.

The communicator 115 is a communication interface for communicating information between the inhaler device 100 and another device. The communicator 115 performs communication in conformity with any wired or wireless communication standard. Such a communication standard may be, for example, wireless LAN (local area network), wired LAN, Wi-Fi (registered trademark), Bluetooth (registered trademark), near-field communication (NFC), or a standard using low-power wide-area (LPWA). In an example, the communicator 115 transmits, to a server, information regarding the user's inhalation. In another example, the communicator 115 receives information regarding a new OS in order to update the information regarding the OS stored in the memory 114.

The controller 116 functions as an arithmetic processing unit and a control circuit, and controls the overall operations of the inhaler device 100 in accordance with various programs. The controller 116 is achieved by, for example, an electronic circuit such as a CPU (central processing unit) or a microprocessor. The controller 116 may also include a ROM (read-only memory) storing programs to be used, operation parameters, and the like and a RAM (random-access memory) that temporarily stores parameters which change as appropriate and the like. The inhaler device 100 performs various types of processing under the control of the controller 116. Examples of the processing controlled by the controller 116 include the supply of power from the power supply 111 to the other structural elements, the charging of the power supply 111, the detection of information by the sensor 112, the notification of information by the notifier 113, the storing and the reading of information by the memory 114, and the communication of information by the communicator 115. The controller 116 also controls other types of processing performed by the inhaler device 100 including inputting of information to each structural element, processing based on information output from each structural elements, and the like.

The container 140 has an internal space 141, and holds the stick substrate 150 while partly accommodating the stick substrate 150 in the internal space 141. The container 140 has an opening 142 that allows the internal space 141 to communicate with the outside, and accommodates the stick substrate 150 inserted into the internal space 141 through the opening 142. For example, the container 140 may be a tubular body having the opening 142 and a bottom 143 on bottom surfaces thereof, and may define the pillar-shaped internal space 141. The container 140 is configured such that inner diameter thereof becomes smaller than outer diameter of the stick substrate 150 at least part of the tubular body in a height direction, and can hold the stick substrate 150 by compressing the stick substrate 150 inserted into the internal space 141 from an outer circumference of the stick substrate 150. The container 140 also has a function of defining a path of air flowing through the stick substrate 150. The bottom 143, for example, has an air inlet hole that is an inlet of air to the airflow path. The opening 142, on the other hand, is an air outlet hole that is an outlet of air from the airflow path.

The stick substrate 150 is a stick-shaped member. The stick substrate 150 includes a substrate 151 and an inhalation port 152.

The substrate 151 includes an aerosol source. When heated, the aerosol source is atomized to generate an aerosol. The aerosol source may be, for example, a material derived from tobacco, such as shredded tobacco or a processed material obtained by forming a tobacco raw material into grains, a sheet, or powder. Alternatively, the aerosol source may include a material that is not derived from tobacco, such as a material made by use of a plant other than tobacco (e.g., mint, an herb, etc.). In an example, the aerosol source may include a flavor component such as menthol. When the inhaler device 100 is a medical inhaler, the aerosol source may include a medicine to be inhaled by a patient. The aerosol source is not limited to a solid, and may be, for example, a liquid such as polyhydric alcohol, which may be glycerine or propylene glycol, or water. The substrate 151 is at least partly accommodated in the internal space 141 of the container 140 with the stick substrate 150 held by the container 140.

The inhalation port 152 is a member held in the user's mouth during inhalation. The inhalation port 152 at least partly protrudes from the opening 142 when the container 140 holds the stick substrate 150. When the user inhales with the inhalation port 152 protruding from the opening 142 held in his/her mouth, air flows into the container 140 through an air inlet hole, which is not illustrated. The flowing air passes through the internal space 141 of the container 140, that is, the substrate 151, and reaches the inside of the user's mouth along with the aerosol generated by the substrate 151.

The stick substrate 150 further includes a susceptor 161. The susceptor 161 produces heat through electromagnetic induction. The susceptor 161 may be a conductive material such as metal. In an example, the susceptor 161 may be a metal sheet. The susceptor 161 is disposed in proximity to the aerosol source. In the example illustrated in FIG. 1, the susceptor 161 is included in the substrate 151 of the stick substrate 150.

Here, the susceptor 161 is disposed in thermal proximity to the aerosol source. The susceptor 161 being disposed in thermal proximity to the aerosol source means that the susceptor 161 is disposed at such a position that heat produced in the susceptor 161 transfers to the aerosol source. For example, the susceptor 161 is included in the substrate 151 along with the aerosol source and surrounded by the aerosol source. With this configuration, heat produced in the susceptor 161 can be efficiently used to heat the aerosol source.

Note that the susceptor 161 may be untouchable from the outside of the stick substrate 150. For example, the susceptor 161 may be distributed in a central part of the stick substrate 150 and need not be distributed near the outer circumference of the stick substrate 150.

The electromagnetic induction source 162 heats the susceptor 161 through induction heating. When an alternating current is supplied, the electromagnetic induction source 162 generates a varying magnetic field (more specifically, an alternating magnetic field). The electromagnetic induction source 162 is disposed at such a position that the generated varying magnetic field overlaps the internal space 141 of the container 140. For example, the electromagnetic induction source 162 is a coiled conductive wire wound around an outer circumference of the container 140. When the varying magnetic field is generated with the stick substrate 150 accommodated in the container 140, therefore, an eddy current is caused at the susceptor 161, thereby generating Joule heat. The aerosol source included in the stick substrate 150 is then heated by the Joule heat and atomized to generate the aerosol. In an example, when the sensor 112 detects a certain user input, power may be supplied and the aerosol may be generated. When the sensor 112 then detects the certain user input again, the supply of power may be stopped. In another example, power may be supplied and the aerosol may be generated while the sensor 112 is detecting the user's inhalation.

The inhaler device 100 is an example of an induction heating system that heats the susceptor 161 through induction heating by generating a varying magnetic field. Here, the aerosol can be generated by combining together the inhaler device 100 and the stick substrate 150. The combination of the inhaler device 100 and the stick substrate 150, therefore, may be regarded as the induction heating system.

### 2. Technical Features

### (1) Detailed Internal Configuration

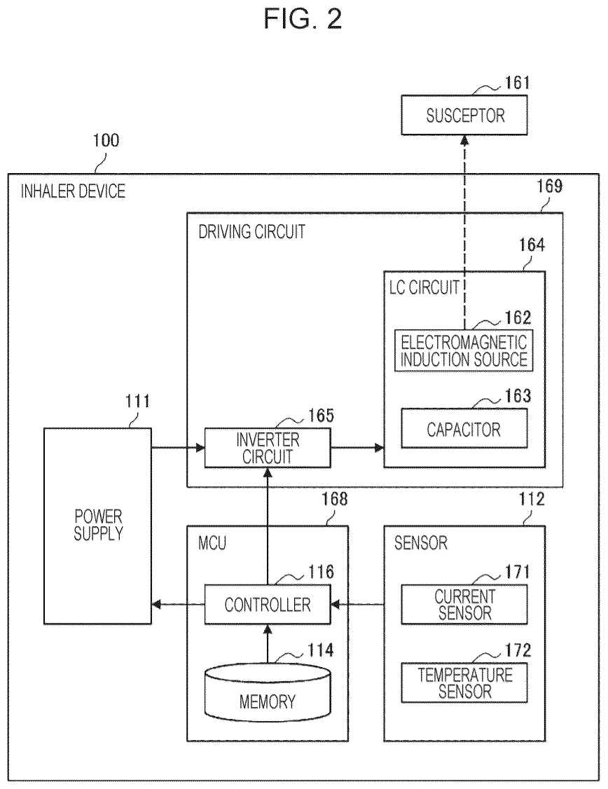

Structural elements related to the induction heating according to the present embodiment will be described in detail with reference to FIG. 2. FIG. 2 is a block diagram illustrating the structural elements related to the induction heating performed by the inhaler device 100 according to the present embodiment.

As illustrated in FIG. 2, the inhaler device 100 includes a driving circuit 169. The driving circuit 169 is a circuit for generating a varying magnetic field for the induction heating. The driving circuit 169 includes an LC circuit 164 and an inverter circuit 165. The LC circuit 164 includes an electromagnetic induction source 162 and a capacitor 163. The capacitor 163 is, for example, a condenser. The LC circuit 164 may be an RLC circuit that further includes a resistor, instead. The driving circuit 169 may further include another circuit such as a matching circuit. The driving circuit 169 operates on power supplied from the power supply 111.

The power supply 111 is a DC (direct current) power supply and supplies direct current power. The inverter circuit 165 converts the direct current power supplied from the power supply 111 into alternating current power. The inverter circuit 165 includes at least one switching element and generates alternating current power by turning on/off the switching element. The inverter circuit 165 is, for example, an H-bridge circuit, a half-bridge circuit, a power MOSFET (metal-oxide-semiconductor field-effect transistor), or the like. The electromagnetic induction source 162 generates a varying magnetic field (more specifically, an alternating magnetic field) using the alternating current power supplied from the inverter circuit 165. When the varying magnetic field generated by the electromagnetic induction source 162 enters the susceptor 161, the susceptor 161 produces heat.

The sensor 112 includes a current sensor 171 and a temperature sensor 172. The current sensor 171 detects information regarding a direct current power supplied from the power supply 111 to the driving circuit 169. The information regarding the direct current power includes a current value and a voltage value. In an example, the sensor 112 may be an MCU (microcontroller unit) with a feedback channel from the power supply 111. The sensor 112 detects a current value and a voltage value of the direct current power supplied to the driving circuit 169 on the basis of feedback from the power supply 111. The temperature sensor 172 detects a temperature. In an example, the temperature sensor 172 detects a temperature of the electromagnetic induction source 162. In this case, the temperature sensor 172 can be disposed near the electromagnetic induction source 162. The temperature sensor 172 may be, for example, a thermistor.

As illustrated in FIG. 2, the controller 116 and the memory 114 may be a single MCU 168. The MCU is an example of a control device. The MCU 168 can include interfaces such as an ADC (analog-to-digital converter) and a DAC (digital-to-analog converter) along with the controller 116 and the memory 114.

The memory 114 stores various items of information regarding the induction heating. In an example, the memory 114 stores a frequency setting table, which will be described later. In another example, the memory 114 stores a heating profile, which will be described later.

The controller 116 controls operation of the electromagnetic induction source 162. In an example, the controller 116 may control operation of the inverter circuit 165 to control an alternating current applied to the LC circuit 164 and, consequently, control the operation of the electromagnetic induction source 162. In another example, the controller 116 may control operation of the power supply 111 to control the direct current power applied to the driving circuit 169 and, consequently, control the operation of the electromagnetic induction source 162.

### (2) Heating Profile

The controller 116 controls the operation of the electromagnetic induction source 162 on the basis of the heating profile. The heating profile is control information for controlling temperature with which the aerosol source is heated. The heating profile may be control information for controlling the temperature of the susceptor 161, instead. In an example, the heating profile can include a target value of the temperature (hereinafter also referred to as a target temperature) of the susceptor 161. The target temperature may change as time elapses from a start of heating, and in this case, the heating profile includes information that defines temporal changes in the target temperature.

The controller 116 controls the supply of power to the driving circuit 169 such that real temperature (hereinafter also referred to as actual temperature) of the susceptor 161 changes in the same manner as the temporal changes in the target temperature defined in the heating profile. As a result, the aerosol is generated as planned in the heating profile. The heating profile is typically designed such that a flavor tasted by the user when the user inhales the aerosol generated from the stick substrate 150 becomes optimal. By controlling the supply of power to the driving circuit 169 on the basis of the heating profile, therefore, the flavor tasted by the user can be made optimal.

The temperature of the susceptor 161 can be estimated on the basis of an electrical resistance of the driving circuit 169. This is because there is an extremely simple relationship between the electrical resistance of the driving circuit 169 and the temperature of the susceptor 161. The controller 116, therefore, estimates the electrical resistance of the driving circuit 169 on the basis of the information regarding the direct current power supplied to the driving circuit 169 detected by the current sensor 171. The controller 116 then estimates the temperature of the susceptor 161 on the basis of the electrical resistance of the driving circuit 169.

The heating profile can include one or more combinations of time elapsed since a start of heating and a target temperature to be reached at the time. The controller 116 controls the temperature of the susceptor 161 on the basis of a difference between a target temperature in the heating profile corresponding to time elapsed since a start of current heating and a current actual temperature. The temperature of the susceptor 161 can be controlled, for example, through known feedback control. In the feedback control, the controller 116 may control power supplied to the electromagnetic induction source 162 on the basis of a difference between the actual temperature and the target temperature or the like. The feedback control may be achieved, for example, by a PID controller (proportional-integral-differential controller). Alternatively, the controller 116 may perform simple on/off control. For example, the controller 116 may supply power to the driving circuit 169 until the actual temperature reaches the target temperature and, when the actual temperature reaches the target temperature, stop supplying power to the driving circuit 169.

The controller 116 can supply power from the power supply 111 to the electromagnetic induction source 162 in the form of a pulse based on pulse width modulation (PWM) or pulse frequency modulation (PFM). In this case, the controller 116 can control the temperature of the susceptor 161 by adjusting a duty ratio of the power pulse in the feedback control. The duty ratio is expressed by the following expression.

$$\begin{matrix}[ Math . 1 ] & \\ D = \frac{τ}{T} & ( 1 )\end{matrix}$$

Here, D denotes the duty ratio. τ denotes pulse width. T denotes a period. The controller 116 controls at least the pulse width T or the period T on the basis of the heating profile.

A period of time from a start to an end of a process for generating the aerosol using the stick substrate 150, or more specifically, a period of time when the electromagnetic induction source 162 operates on the basis of the heating profile, will be referred to as a heating session hereinafter. The start of the heating session is a time at which heating based on the heating profile starts. The end of the heating session is a time when a sufficient amount of aerosol is no longer generated. The heating session includes a preheating period in a first half and a puffable period in a second half. The puffable period is a period when a sufficient amount of aerosol is assumed to be generated. The preheating period is a period from a start of induction heating until the user becomes able to inhale the aerosol, that is, until the puffable period starts. Heating performed in the preheating period will also be referred to as preheating.

### (3) Control of Driving Frequency

The controller 116 controls a frequency (hereinafter also referred to as a driving frequency) of the alternating current applied to the LC circuit 164. More specifically, the controller 116 controls the inverter circuit 165 such that the frequency of the alternating current applied to the LC circuit 164 becomes a resonant frequency of the LC circuit 164. By setting the frequency of the alternating current applied to the LC circuit 164 at the resonant frequency of the LC circuit 164, the susceptor 161 can be efficiently heated as described hereinafter.

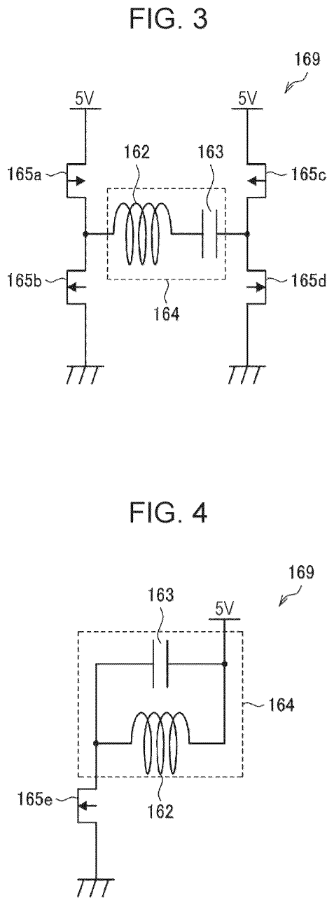

FIG. 3 is a diagram illustrating configuration of the driving circuit 169 according to the present embodiment. As illustrated in FIG. 3, the LC circuit 164 may be an LC series circuit where the electromagnetic induction source 162 and the capacitor 163 are connected in series with each other. When the LC circuit 164 is an LC series circuit, amplitude of the current flowing to the LC circuit 164 is maximized by driving the LC circuit 164 at the resonant frequency. As a result, because the current flowing to a current flowing to the electromagnetic induction source 162 is maximized, the temperature of the susceptor 161 can be increased most efficiently. In the example illustrated in FIG. 3, the inverter circuit 165 is an H-bridge circuit including four power MOSFETs 165a to 165d.

FIG. 4 is a diagram illustrating another example of the configuration of the driving circuit 169 according to the present embodiment. As illustrated in FIG. 4, the LC circuit 164 may be an LC parallel circuit where the electromagnetic induction source 162 and the capacitor 163 are connected in parallel with each other. When the LC circuit 164 is an LC parallel circuit, an oscillation current of maximum amplitude flows to the LC circuit 164, which is a closed circuit, by driving the LC circuit 164 at the resonant frequency. As a result, the temperature of the susceptor 161 can be increased most efficiently. In the example illustrated in FIG. 4, the inverter circuit 165 is a power MOSFET 165e.

In particular, the LC circuit 164 is desirably an LC series circuit. When the LC circuit 164 is an LC series circuit, a switching loss is reduced, and counter-electromotive force can be controlled. As a result, the temperature of the susceptor 161 can be increased more efficiently than when the LC circuit 164 is an LC parallel circuit.

Here, in the course of the induction heating, the temperature of the electromagnetic induction source 162 increases. This is because the temperature of the electromagnetic induction source 162 increases as a current is applied. In addition, the temperature of the electromagnetic induction source 162 can be increased due to heat transferred from the susceptor 161. As the temperature of the electromagnetic induction source 162 varies, the resonant frequency of the LC circuit 164 varies.

The controller 116, therefore, varies the frequency of the alternating current applied to the LC circuit 164 in accordance with the variation in the temperature of the electromagnetic induction source 162. The frequency of the alternating current applied to the LC circuit 164 corresponds to the resonant frequency of the LC circuit 164. That is, the controller 116 temporally varies the frequency of the alternating current applied to the LC circuit 164 such that the frequency becomes the resonant frequency of the LC circuit 164 corresponding to the temperature of the electromagnetic induction source 162. With this configuration, the frequency of the alternating current applied to the LC circuit 164 can be caused to follow the variation in the resonant frequency of the LC circuit 164, which accompanies the variation in the temperature of the electromagnetic induction source 162. As a result, a decrease in heating efficiency of the susceptor 161 caused by the variation in the temperature of the electromagnetic induction source 162 can be prevented, thereby improving the heating efficiency of the susceptor 161.

Here, the frequency of the alternating current applied to the LC circuit 164 corresponds to the period of the PWM control. That is, the controller 116 controls the period T included in the above expression (1) as the control of the frequency of the alternating current applied to the LC circuit 164.

The temperature sensor 172 can detect the temperature of the electromagnetic induction source 162 in real-time. The controller 116, therefore, may control the frequency of the alternating current applied to the LC circuit 164 on the basis of a temperature detected by the temperature sensor 172 after the start of the application (i.e., during the application) of the alternating current to the LC circuit 164. More specifically, the controller 116 sets the frequency of the alternating current applied to the LC circuit 164 at the resonant frequency of the LC circuit 164 corresponding to the temperature of the electromagnetic induction source 162 detected in real-time during a heating session. With this configuration, the frequency of the alternating current applied to the LC circuit 164 can be caused to follow the variation in the resonant frequency of the LC circuit 164, which accompanies the variation in the temperature of the electromagnetic induction source 162. That is, the controller 116 can continue to drive the LC circuit 164 with the resonant frequency even if the temperature of the electromagnetic induction source 162 varies. The heating efficiency of the susceptor 161, therefore, can be improved.

More specifically, the controller 116 controls the frequency of the alternating current applied to the LC circuit 164 on the basis of the frequency setting table stored in the memory 114. The frequency setting table is a table that defines correspondence between a temperature and the frequency of the alternating current applied to the LC circuit 164 when the temperature sensor 172 detects the temperature. After starting to apply the alternating current to the LC circuit 164, the controller 116 obtains the temperature of the electromagnetic induction source 162 detected by the temperature sensor 172. The controller 116 then operates the inverter circuit 165 with a frequency corresponding to the temperature of the electromagnetic induction source 162 in the frequency setting table. Since the frequency to be set is defined in advance, a processing load of the controller 116 can be reduced.

Here, the temperature sensor 172 detects a temperature a plurality of times in a heating session. The controller 116, therefore, can switch the frequency of the alternating current on the basis of the frequency setting table one or more times. The temperature sensor 172 may detect a temperature at certain time intervals. That is, the controller 116 may switch the frequency of the alternating current on the basis of the frequency setting table at certain time intervals.

A following table 1 is an example of the frequency setting table.

TABLE 1
Example of frequency setting table

| | Temperature of electromagnetic | | | | | |
|---|---|---|---|---|---|---|
| | induction source 162 (° C.) | | | | | |
| | 0 | 10 | 20 | 30 | 40 | 50 |
| Frequency (kHz) | A | A + 1 | A + 2 | A + 3 | A + 4 | A + 5 |

According to the above table 1, the controller 116 sets the frequency of the alternating current applied to the LC circuit 164 at A [kHz] when the temperature of the electromagnetic induction source 162 is 0° C. In addition, when the temperature of the electromagnetic induction source 162 is 10° C., the controller 116 sets the frequency of the alternating current applied to the LC circuit 164 at (A+1) [kHz] when the temperature of the electromagnetic induction source 162 is 10° C.

As for temperatures that are not defined in the frequency setting table, the controller 116 may approximate corresponding frequencies. For example, the controller 116 may proportionally calculate a frequency at a time when the temperature of the electromagnetic induction source 162 is 25° C. from the frequency at a time when the temperature of the electromagnetic induction source 162 is 20° C. and the frequency at a time when the temperature of the electromagnetic induction source 162 is 30° C. In this case, the controller 116 can set (A+2.5) [kHz], which is an average of (A+2) [kHz] and (A+3) [kHz], as the driving frequency of the inverter circuit 165.

The frequency setting table can be generated in advance at a factory where the inhaler device 100 is manufactured, and stored in the memory 114. The frequency setting table is generated by identifying resonant frequencies for each of different temperatures of the electromagnetic induction source 162. The resonant frequencies for the different temperatures of the electromagnetic induction source 162 are identified by repeating, while changing the temperature of the electromagnetic induction source 162, a process where a current flowing to the driving circuit 169 is measured and a resonant frequency is identified while changing the frequency over time. Due to manufacturing variation in the MCU 168 and the LC circuit 164, the resonant frequency can vary. A frequency setting table, therefore, is desirably generated for each inhaler device 100.

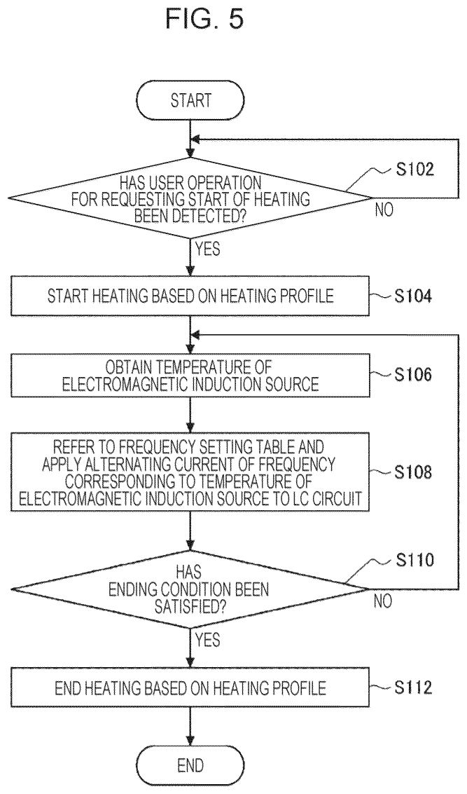

An example of a procedure of a heating process performed by the inhaler device 100 will be described hereinafter with reference to FIG. 5. FIG. 5 is a flowchart illustrating the example of the procedure of the heating process performed by the inhaler device 100 according to the present embodiment.

As illustrated in FIG. 5, first, the controller 116 determines whether a user operation for requesting a start of heating has been detected (step S102). An example of the user operation for requesting a start of heating is an operation performed on the inhaler device 100, such as use of a switch or the like provided for the inhaler device 100. Another example of the user operation for requesting a start of heating is insertion of the stick substrate 150 into the inhaler device 100.

If determining that a user operation for requesting a start of heating has not been detected (step S102: NO), the controller 116 waits until a user operation for requesting a start of heating is detected.

If determining that a user operation for requesting a start of heating has been detected (step S102: YES), on the other hand, the controller 116 start heating based on a heating profile (step S104). For example, the controller 116 controls the pulse width T of the PWM control such that the actual temperature of the susceptor 161 changes in the same manner as temporal changes in the target temperature defined in the heating profile.

Next, the controller 116 obtains the temperature of the electromagnetic induction source 162 (step S106). The temperature sensor 172 detects the temperature of the electromagnetic induction source 162.

Next, the controller 116 refers to the frequency setting table and controls the operation of the inverter circuit 165 such that the alternating current of the frequency corresponding to the temperature of the electromagnetic induction source 162 is applied to the LC circuit 164 (step S108). For example, the controller 116 operates the inverter circuit 165 with A [kHz] when the temperature of the electromagnetic induction source 162 is 0° C. and (A+1) [kHz] when the temperature of the electromagnetic induction source 162 is 10° C.

The controller 116 then determines whether an ending condition has been satisfied (step S110). An example of the ending condition is elapse of a certain period of time since the start of the heating. Another example of the ending condition is that the number of puffs since the start of the heating reaches a certain number of times.

If the controller 116 determines that the ending condition has not been satisfied (step S110: NO), the process returns to step S106.

If determining that the ending condition has been satisfied (step S110: YES), on the other hand, the controller 116 ends the heating based on the heating profile (step S112). The process then ends.

### (4) Result of Experiment

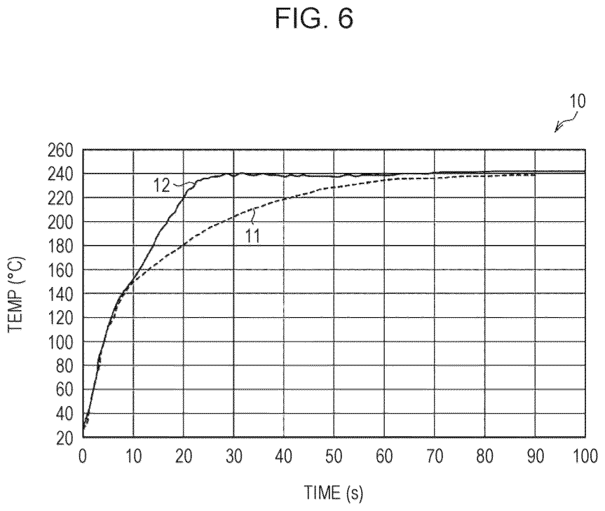

Effects produced by the present embodiment will be described hereinafter with reference to FIG. 6.

FIG. 6 is a graph illustrating a result of an experiment for checking the effects produced by the present embodiment. A horizontal axis of a graph 10 represents time. A vertical axis of the graph 10 represents the temperature of the stick substrate 150. Aline 11 indicates changes in the temperature of the stick substrate 150 at a time when the frequency of the alternating current applied to the LC circuit 164 is fixed at the resonant frequency of the LC circuit 164 corresponding to the initial temperature of the electromagnetic induction source 162. A line 12 indicates changes in the temperature of the stick substrate 150 at a time when the frequency of the alternating current applied to the LC circuit 164 is temporally changed in such a way as to match the resonant frequency of the LC circuit 164 corresponding to the temperature of the electromagnetic induction source 162 at different points in time.

As can be seen from the line 11, it takes about 70 seconds for the temperature of the stick substrate 150 to reach around 240° C., which is the highest temperature. As can be seen from the line 12, it takes about 25 seconds for the temperature of the stick substrate 150 to reach around 240° C., which is the highest temperature. That is, by controlling the driving frequency as in the present embodiment, time taken for the temperature of the stick substrate 150 to reach around 240° C., which is the highest temperature, can be reduced by 40 seconds or more compared to when the driving frequency is not controlled as in the present embodiment.

According to the present embodiment, the heating efficiency can thus be improved. As a result, preheating time can be reduced. Furthermore, power consumption can be reduced.

### 3. Supplementary Information

Although a preferred embodiment of the present invention has been described in detail with reference to the accompanying drawings, the present invention is not limited to this example. It is clear that those who have ordinary knowledge in a technical field to which the present invention pertains can conceive various examples of alterations or modifications within the scope of the technical idea described in the claims, and it is understood that these also naturally belong to the technical scope of the present invention.

Although an example where the stick substrate 150 includes the susceptor 161 has been described in the above embodiment, the present invention is not limited to this example. The susceptor 161 may be provided for the inhaler device 100, instead. In an example, the inhaler device 100 may include the susceptor 161 provided outside the internal space 141. More specifically, the container 140 may be composed of a conductive, magnetic material and function as the susceptor 161. Since the container 140 as the susceptor 161 comes into contact with an outer circumference of the substrate 151, the container 140 can come into thermal proximity to the aerosol source included in the substrate 151. In another example, the inhaler device 100 may include the susceptor 161 provided inside the internal space 141. More specifically, the susceptor 161 formed as a blade may be provided in such a way as to protrude into the internal space 141 of the container 140 from the bottom 143. When the stick substrate 150 is inserted into the internal space 141 of the container 140, the blade-shaped susceptor 161 is inserted into the stick substrate 150 in such a way as to penetrate into the substrate 151 of the stick substrate 150. As a result, the blade-shaped susceptor 161 can come into thermal proximity to the aerosol source included in the substrate 151.

Although an example where the heating profile includes a target value of the temperature of the susceptor 161 has been described in the above embodiment, the present invention is not limited to this example. It is only required that the heating profile include a target value of a parameter related to the temperature with which the aerosol source is heated. The parameter related to the temperature with which the aerosol source is heated may be the electrical resistance of the driving circuit 169.

It is to be noted that the process by each device described herein may be achieved by software, hardware, or a combination of software and hardware. A program constituting software is stored in advance, for example, in a storage medium (more specifically, a non-transitory computer-readable storage medium) provided inside or outside each device. When executed by a computer that controls each device described herein, for example, each program is loaded into a RAM and executed by a processing circuit such as CPU. The storage medium is, for example, a magnetic disk, an optical disc, a magneto-optical disk, a flash memory, or the like. In addition, the computer program may be distributed over a network, instead, without using a storage medium. In addition, the computer may be an integrated circuit for a specific application such as an ASIC, a general-purpose processor that executes a function by reading a software program, a computer on a server used for cloud computing, or the like. In addition, the process by each device described herein may be performed by a plurality of computers in a distributed manner.

In addition, the process described herein with reference to the flowchart and the sequence diagram need not necessarily be performed in the illustrated order. Some processing steps may be performed in parallel with each other, instead. Additional processing steps may also be employed, or some processing steps may be omitted.

The following configurations also belong to the technical scope of the present invention.

(1)

An induction heating system including:
an LC circuit including an electromagnetic induction source that generates a varying magnetic field;
a temperature sensor that detects a temperature; and
a controller that controls frequency of an alternating current applied to the LC circuit on a basis of the temperature detected by the temperature sensor after a start of the application of the alternating current to the LC circuit.
   (2)

The induction heating system according to (1), further including:
a memory storing correspondence between a temperature and the frequency of the alternating current applied to the LC circuit when the temperature sensor detects the temperature,
wherein the controller controls the frequency of the alternating current applied to the LC circuit on a basis of the correspondence stored in the memory.
   (3)

The induction heating system according to (1) or (2),
in which the temperature sensor detects a temperature of the electromagnetic induction source.
   (4)

The induction heating system according to any of (1) to (3),
in which the frequency of the alternating current applied to the LC circuit corresponds to a resonant frequency of the LC circuit.
   (5)

The induction heating system according to any of (1) to (4),
in which the LC circuit is an LC series circuit.
   (6)

The induction heating system according to any of (1) to (5), further including:
a container that accommodates a substrate including an aerosol source,
in which the electromagnetic induction source heats, through induction heating, a susceptor disposed in thermal proximity to the aerosol source.
   (7)

The induction heating system according to (6),
in which the substrate includes the susceptor.
   (8)

The induction heating system according to (6), further including:
the susceptor.
   (9)

The induction heating system according to any of (6) to (8), further including:
the substrate.
   (10)

The induction heating system according to (2),
in which the controller and the memory are a single control device.
   (11)

A control method for controlling an induction heating system including an LC circuit that includes an electromagnetic induction source which generates a varying magnetic field and a temperature sensor that detects a temperature, the control method including:
controlling frequency of an alternating current applied to the LC circuit on a basis of the temperature detected by the temperature sensor after a start of the application of the alternating current to the LC circuit.
   (12)

A program executed by a computer that controls an induction heating system including an LC circuit that includes an electromagnetic induction source which generates a varying magnetic field and a temperature sensor that detects a temperature, the program causing the computer to function as:
a controller that controls frequency of an alternating current applied to the LC circuit on a basis of the temperature detected by the temperature sensor after a start of the application of the alternating current to the LC circuit.

### REFERENCE SIGNS LIST

100 inhaler device
111 power supply
112 sensor
113 notifier
114 memory
115 communicator
116 controller
140 container
141 internal space
142 opening
143 bottom
150 stick substrate
151 substrate
152 inhalation port
161 susceptor
162 electromagnetic induction source
163 capacitor
164 LC circuit
165 inverter circuit
168 MCU
169 driving circuit
171 current sensor
172 temperature sensor

1. An induction heating system comprising:
an LC circuit including an electromagnetic induction source that generates a varying magnetic field;
a temperature sensor that detects a temperature; and
a controller that controls frequency of an alternating current applied to the LC circuit on a basis of the temperature detected by the temperature sensor after a start of the application of the alternating current to the LC circuit.

2. The induction heating system according to claim 1, further comprising:
a memory storing correspondence between a temperature and the frequency of the alternating current applied to the LC circuit when the temperature sensor detects the temperature,
wherein the controller controls the frequency of the alternating current applied to the LC circuit on a basis of the correspondence stored in the memory.

3. The induction heating system according to claim 1,
wherein the temperature sensor detects a temperature of the electromagnetic induction source.

4. The induction heating system according to claim 1,
wherein the frequency of the alternating current applied to the LC circuit corresponds to a resonant frequency of the LC circuit.

5. The induction heating system according to claim 1,
wherein the LC circuit is an LC series circuit.

6. The induction heating system according to claim 1, further comprising:
a container that accommodates a substrate including an aerosol source,
wherein the electromagnetic induction source heats, through induction heating, a susceptor disposed in thermal proximity to the aerosol source.

7. The induction heating system according to claim 6,
wherein the substrate includes the susceptor.

8. The induction heating system according to claim 6, further comprising:
the susceptor.

9. The induction heating system according to claim 6, further comprising:
the substrate.

10. The induction heating system according to claim 2,
wherein the controller and the memory are a single control device.

11. A control method for controlling an induction heating system including an LC circuit that includes an electromagnetic induction source which generates a varying magnetic field and a temperature sensor that detects a temperature, the control method comprising:
controlling frequency of an alternating current applied to the LC circuit on a basis of the temperature detected by the temperature sensor after a start of the application of the alternating current to the LC circuit.

12. A non-transitory computer readable medium having a program stored therein, the program executed by a computer that controls an induction heating system including an LC circuit that includes an electromagnetic induction source which generates a varying magnetic field and a temperature sensor that detects a temperature, the program causing the computer to function as:
a controller that controls frequency of an alternating current applied to the LC circuit on a basis of the temperature detected by the temperature sensor after a start of the application of the alternating current to the LC circuit.
